(19) United States
(12) Patent Application Publication
(10) Pub. No.: US 2003/0214936 A1
(43) Pub. Date: Nov. 20, 2003

(54) Using GPS signals to synchronize stationary multiple master networks

(76) Inventor: Max K. Goff, Reno, NV (US)

Correspondence Address: PARK, VAUGHAN & FLEMING LLP, 508 SECOND STREET, SUITE 201, DAVIS, CA, 95616, US

(21) Appl. No.: 10/147,201

(22) Filed: May 16, 2002

(51) Int. Cl. H04J 3/06; H04B 7/185

(52) U.S. Cl. 370/350; 370/316

(57) ABSTRACT

One embodiment of the present invention provides a system that uses Global Positioning System (GPS) signals to synchronize multiple masters on a stationary network. During operation, the system receives the GPS signals at the multiple masters. Next, the system extracts a time value from the GPS signals at each master, and uses the extracted time value to synchronize a local clock at each master. The system subsequently uses the local clock at each master to synchronize interactions between masters.

### BACKGROUND

2. Field of the Invention

The present invention relates to distributed computing systems. More specifically, the present invention relates to a method and an apparatus for using Global Positioning System (GPS) signals to synchronize multiple masters on a stationary network.

2. Related Art

As computer networks continue to proliferate, it is becoming progressively easier for geographically distributed computer systems to work together in performing computational tasks. Historically, such cooperation has been limited by significant delays and bandwidth limitations involved in communicating between geographically distributed computer systems—which may possibly be separated by thousands of miles.

However, as the networking infrastructure continues to improve, these delays and bandwidth limitations have been dramatically reduced. This makes it possible for a distributed application to effectively operate on a set of geographically distributed computing nodes in the same way as a distributed application operates on a set of local computing nodes in a local cluster. For example, it is theoretically possible to execute a distributed application that performs load balancing and provides fault-tolerance across a set of geographically distributed computing nodes.

However, synchronizing activities between geographically distributed computing nodes can be very challenging. Unlike computing nodes in a tightly coupled parallel processing system, geographically distributed computing nodes do not share a centralized clock signal that can be used to synchronize the computing nodes. Furthermore, unlike nodes in a local cluster, geographically distributed computing nodes do not share a local network through which synchronization commands can be sent to synchronize the computing nodes.

What is needed is a method and an apparatus that facilitates synchronizing actions of a set of geographically distributed computing nodes.

### SUMMARY

One embodiment of the present invention provides a system that uses Global Positioning System (GPS) signals to synchronize multiple masters on a stationary network. During operation, the system receives the GPS signals at the multiple masters. Next, the system extracts a time value from the GPS signals at each master, and uses the extracted time value to synchronize a local clock at each master. The system subsequently uses the local clock at each master to synchronize interactions between masters.

In a variation on this embodiment, the system additionally sends a synchronization signal from a master on the stationary network to a slave that does not possess a GPS receiver. This enables the slave to synchronize its local clock signal with the master.

In a variation on this embodiment, extracting the time value from the GPS signals involves using Universal Coordinated Time (UTC) correction parameters in the GPS signals to convert a GPS time value into a UTC time value.

In a variation on this embodiment, extracting the time value from the GPS signals involves using Standard Positioning Service (SPS) signals within the GPS signals to obtain a time value that is accurate to within 340 nanoseconds.

In a variation on this embodiment, extracting the time value from the GPS signals involves using Precise Positioning Service (PPS) signals within the GPS signals to obtain a time value that is accurate to within 200 nanoseconds.

In a variation on this embodiment, receiving the GPS signals involves receiving differential GPS signals in addition to standard GPS signals.

In a variation on this embodiment, receiving the GPS signals involves receiving Wide Area Augmentation System (WAAS) signals in addition to standard GPS signals.

In a variation on this embodiment, receiving the GPS signals involves receiving Local Area Augmentation System (LAAS) signals in addition to standard GPS signals.

In a variation on this embodiment, each master includes a computer system coupled to the stationary network.

In a variation on this embodiment, the multiple masters are geographically distributed.

### BRIEF DESCRIPTION OF THE FIGURES

FIG. 1 illustrates a distributed computing system in accordance with an embodiment of the present invention.

FIG. 2 is a flow chart illustrating the process of using GPS signals to synchronize multiple masters on a stationary network in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The data structures and code described in this detailed description are typically stored on a computer-readable storage medium, which may be any device or medium that can store code and/or data for use by a computer system. This includes, but is not limited to, magnetic and optical storage devices such as disk drives, magnetic tape, CDs (compact discs) and DVDs (digital versatile discs or digital video discs), and computer instruction signals embodied in a transmission medium (with or without a carrier wave upon which the signals are modulated). For example, the transmission medium may include a communications network, such as the Internet.

Distributed Computing System

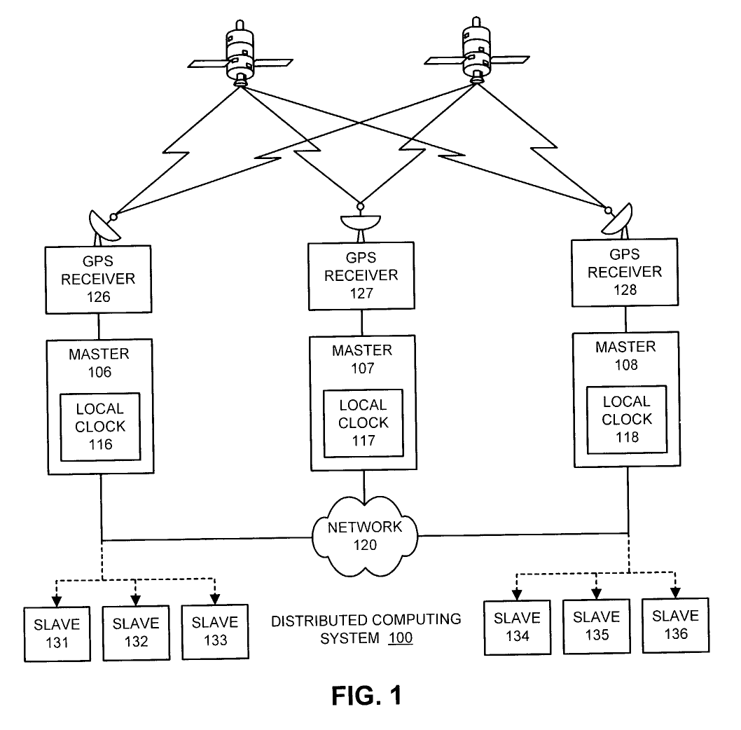

FIG. 1 illustrates a distributed computing system 100 in accordance with an embodiment of the present invention. Distributed computing system 100 includes a number of master computing nodes 106-108, which are coupled to network 120. Master computing nodes 106-108 may include geographically distributed computing nodes, or alternatively, may include nodes that are part of the same local network or cluster. Network 120 can generally include any type of wire or wireless communication channel capable of coupling together computing nodes. This includes, but is not limited to, a local area network, a wide area network, or a combination of networks. In one embodiment of the present invention, network 120 includes the Internet.

Note that master computing node 106 communicates with slave computing nodes 131-133, and master computing node 108 communicates with slave computing nodes 134-136. This communication can take place through separate local area networks, or alternatively, through network 120.

Master computing nodes 104-106 and slave computing nodes 131-136 can generally include any type of computer system, including, but not limited to, a computer system based on a microprocessor, a mainframe computer, a digital signal processor, a device controller, and a computational engine within an appliance.

Master computing nodes 106-108 are coupled to Global Positioning System (GPS) receivers 126-128, respectively. GPS receivers 126-128 communicate with one or more GPS satellites 101-102 to obtain time base information. Note that signals from two different GPS satellites are required to determine a geographical location. However, once a geographical location of a receiver is known, only signals from one GPS satellite are needed to determine time base information.

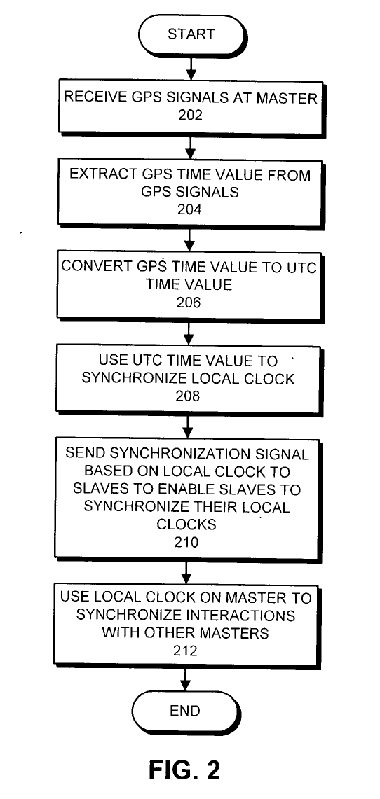

Master computing nodes 104-106 use time base information obtained through GPS receivers 126-128 to periodically synchronize local clocks 116-118 within master computing nodes 106-108, respectively. Master computing node 106 can then communicate with slave computing nodes 131-133 to synchronize local clocks on slave computing nodes 131 -133 (note shown). Master computing node 108 can similarly communicate with slave computing nodes 134-136 to synchronize local clocks on slave computing nodes 134-136 (not shown). This synchronization process is described in more detail below with reference to FIG. 2.

Process of Synchronizing Local Clock Signals

FIG. 2 is a flow chart illustrating the process of using GPS signals to synchronize multiple masters on a stationary network in accordance with an embodiment of the present invention.

The system starts by receiving GPS signals at master computing nodes 104-106 (step 202). In order to obtain more accuracy, this may involve additionally receiving differential GPS (DGPS) signals, Wide Area Augmentation System (WAAS) signals, or Local Area Augmentation System (LAAS) signals. DGPS signals and LAAS signals are additional signals that are received from a ground station to provide additional accuracy, while the WAAS signals are additional signals that are received from geosynchronous satellites to provide additional accuracy.

Next, the system extracts a GPS time value from the GPS signals at master computing nodes 104-106 (step 204). Note that extracting the time value from the GPS signals can involve using Precise Positioning Service (PPS) signals within the GPS signals to obtain a time value that is accurate to within 200 nanoseconds. Alternatively, it can involve using Standard Positioning Service (SPS) signals within the GPS signals to obtain a time value that is accurate to within 340 nanoseconds.

Note that PPS signals have historically only been available to authorized users with cryptographic equipment and keys and specially equipped receivers, such as U.S. and Allied military, certain U.S. Government agencies, and selected civil users specifically approved by the U.S. Government. Other users had to use the Standard Positioning Service, which is somewhat less accurate in specifying geographical locations and times.

Next, the system optionally converts the GPS time values into corresponding Universal Coordinated Time (UTC) time values by using UTC correction parameters contained in the GPS signals (step 206). Note that GPS time does not take into account leap seconds and is consequently drifting ahead of UTC time.

The system then uses the UTC time values to synchronize (reset) the local clocks 116-118 at master computing nodes 106-108 (step 208).

Master computing nodes 106-108 can then send synchronization signals to slave computing nodes (step 210). In particular, master computing node 106 can send synchronization signals to slave computing nodes 131-133. These synchronization signals enable slave computing nodes 131-133 to synchronize their local clocks with local clock 116 in master computing node 106. Similarly, master computing node 108 can send synchronization signals to slave computing nodes 134-136. These synchronization signals enable slave computing nodes 134-136 to synchronize their local clocks with local clock 118 in master computing node 108.

Next, the system uses local clocks 116-118 within master computing nodes 106-108, respectively, to synchronize interactions between master computing nodes 106-108 (step 212). For example, because they have a consistent time base, master computing nodes 106-108 can communicate with each other through fast protocols that do not continually require acknowledgement signals.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A method for using Global Positioning System (GPS) signals to synchronize multiple masters on a stationary network, comprising:
receiving the GPS signals at the multiple masters on the stationary network;
extracting a time value from the GPS signals at each master;
using the extracted time value to synchronize a local clock at each master; and
using the local clock at each master to synchronize interactions between masters.

2. The method of claim 1, further comprising sending a synchronization signal from a master on the stationary network to a slave, which does not possess a GPS receiver, in order to synchronize a local clock on the slave with the local clock on the master.

3. The method of claim 1, wherein extracting the time value from the GPS signals involves using Universal Coordinated Time (UTC) correction parameters in the GPS signals to convert a GPS time value into a UTC time value.

4. The method of claim 1, wherein extracting the time value from the GPS signals involves using Standard Positioning Service (SPS) signals within the GPS signals to obtain a time value that is accurate to within 340 nanoseconds.

5. The method of claim 1, wherein extracting the time value from the GPS signals involves using Precise Positioning Service (PPS) signals within the GPS signals to obtain a time value that is accurate to within 200 nanoseconds.

6. The method of claim 1, wherein receiving the GPS signals involves receiving differential GPS signals in addition to GPS signals.

7. The method of claim 1, wherein receiving the GPS signals involves receiving Wide Area Augmentation System (WAAS) signals in addition to GPS signals.

8. The method of claim 1, wherein receiving the GPS signals involves receiving Local Area Augmentation System (LAAS) signals in addition to GPS signals.

9. The method of claim 1, wherein each master includes a computer system coupled to the stationary network.

10. The method of claim 1, wherein the multiple masters are geographically distributed.

11. A computer-readable storage medium storing instructions that when executed by a computer cause the computer to perform a method for using Global Positioning System (GPS) signals to synchronize multiple masters on a stationary network, the method comprising:
receiving the GPS signals at the multiple masters on the stationary network;
extracting a time value from the GPS signals at each master;
using the extracted time value to synchronize a local clock at each master; and
using the local clock at each master to synchronize interactions between masters.

12. The computer-readable storage medium of claim 11, wherein the method further comprises sending a synchronization signal from a master on the stationary network to a slave, which does not possess a GPS receiver, in order to synchronize a local clock on the slave with the local clock on the master.

13. The computer-readable storage medium of claim 11, wherein extracting the time value from the GPS signals involves using Universal Coordinated Time (UTC) correction parameters in the GPS signals to convert a GPS time value into a UTC time value.

14. The computer-readable storage medium of claim 11, wherein extracting the time value from the GPS signals involves using Standard Positioning Service (SPS) signals within the GPS signals to obtain a time value that is accurate to within 340 nanoseconds.

15. The computer-readable storage medium of claim 11, wherein extracting the time value from the GPS signals involves using Precise Positioning Service (PPS) signals within the GPS signals to obtain a time value that is accurate to within 200 nanoseconds.

16. The computer-readable storage medium of claim 11, wherein receiving the GPS signals involves receiving differential GPS signals in addition to GPS signals.

17. The computer-readable storage medium of claim 11, wherein receiving the GPS signals involves receiving Wide Area Augmentation System (WAAS) signals in addition to GPS signals.

18. The computer-readable storage medium of claim 11, wherein receiving the GPS signals involves receiving Local Area Augmentation System (LAAS) signals in addition to GPS signals.

19. The computer-readable storage medium of claim 11, wherein each master includes a computer system coupled to the stationary network.

20. The computer-readable storage medium of claim 11, wherein the multiple masters are geographically distributed.

21. An apparatus that uses Global Positioning System (GPS) signals to synchronize multiple masters on a stationary network, comprising:
multiple masters on the stationary network;
a receiver within each master that is configured to receive the GPS signals;
a local clock within each master;
an extraction mechanism within each master that is configured to extract a time value from the GPS signals;
a synchronization mechanism within each master that is configured to use the extracted time value to synchronize the local clock at the master; and
an interaction mechanism within each master that is configured to use the local clock at the master to synchronize interactions with other masters on the stationary network.

22. The apparatus of claim 21, further comprising a sending mechanism within a master that is configured to send a synchronization signal from the master to a slave, which does not possess a GPS receiver, in order to synchronize a local clock on the slave with the local clock on the master.

23. The apparatus of claim 21, wherein the extraction mechanism is configured to use Universal Coordinated Time (UTC) correction parameters in the GPS signals to convert a GPS time value into a UTC time value.

24. The apparatus of claim 21, wherein the extraction mechanism is configured to use Standard Positioning Service (SPS) signals within the GPS signals to obtain a time value that is accurate to within 340 nanoseconds.

25. The apparatus of claim 21, wherein the extraction mechanism is configured to use Precise Positioning Service (PPS) signals within the GPS signals to obtain a time value that is accurate to within 200 nanoseconds.

26. The apparatus of claim 21, wherein the receiver within each master is configured to receive differential GPS signals in addition to GPS signals.

27. The apparatus of claim 21, wherein the receiver within each master is configured to receive Wide Area Augmentation System (WAAS) signals in addition to GPS signals.

28. The apparatus of claim 21, wherein the receiver within each master is configured to receive Local Area Augmentation System (LAAS) signals in addition to GPS signals.

29. The apparatus of claim 21, wherein each master includes a computer system coupled to the stationary network.

30. The apparatus of claim 21, wherein the multiple masters are geographically distributed.
